(19) United States
(12) Patent Application Publication
(10) Pub. No.: US 2014/0025295 A1
(43) Pub. Date: Jan. 23, 2014

(54) Route Planning Method and Apparatus

(71) Applicants: Boris Paul, Bonn (DE); Verena Wild, Bonn (DE); Keith Ulrich, Bonn-Oberkassel (DE)

(72) Inventors: Boris Paul, Bonn (DE); Verena Wild, Bonn (DE); Keith Ulrich, Bonn-Oberkassel (DE)

(73) Assignee: Deutsche Post AG, Bonn (DE)

(21) Appl. No.: 13/880,888

(22) PCT Filed: Oct. 20, 2011
(86) PCT No.: PCT/EP2011/068294

§ 371 Date: Apr. 22, 2013

(30) Foreign Application Priority Data
Oct. 22, 2010 (DE) 10 2010 042 813.2

(51) Int. Cl. G01C 21/34

(52) U.S. Cl. CPC G01C 21/343
USPC 701/527

(57) ABSTRACT

The subject innovation relates to a method for planning routes which each run along a plurality of locations and for each of which a sequence of locations is determined according to distances between the locations. The distances between first locations on a first route are stored in a memory in conjunction with the determination of the first route, and a subsequent, second tour is determined according to distances between locations on the second route which are stored in the memory and according to further distances between locations on the second route, wherein the further distances are supplemented in the memory. The subject innovation also relates to an apparatus which is suitable for carrying out the method. The subject innovation can be used, in particular, to plan routes for delivering and/or collecting items of mail.

### CROSS-REFERENCE TO RELATED APPLICATIONS

Pursuant to 35 U.S.C. §371, this application is the United States National Stage Application of International Patent Application No. PCT/EP2011/068294, filed on Oct. 20, 2011, the contents of which are incorporated by reference as if set forth in their entirety herein, which claims priority to German (DE) Patent Application No. 10 2010 042813.2, filed Oct. 22, 2010, the contents of which are incorporated by reference as if set forth in their entirety herein.

### BACKGROUND

Route planning is undertaken in numerous sectors that have to do with delivering goods and/or stopping at numerous locations, and it comprises the determination of an optimal sequence in which the locations where certain tasks have to be performed are serviced. An example of a sector in which route planning is of great significance is the delivery and pick-up of packages and parcels or other mailpieces for which purpose deliverers follow routes containing changing addresses once or more per day.

Route planning is especially carried out by taking into account the addresses that have to be serviced. Input variables of the route planning are may be the distances between the locations, which can be indicated, for instance, in a distance matrix and which can be computed before the actual route is planned.

German patent 10 2004 019 232 B4 describes a method for route planning in which, in particular, the sequence of addresses where objects have to be delivered and/or picked up is determined so that each route can be planned on the basis of geographic data.

In order to be able to carry out the route planning on the basis of the geographic data, the distances between the addresses to be serviced have to be determined However, in view of the numerous addresses that typically have to be taken into account during the route planning for delivering packages and parcels and/or other mailpieces, this calls for a great deal of computation work and is very time-consuming.

### SUMMARY

The subject innovation relates to the planning of routes, especially the routes of mail carriers. In this context, the subject innovation relates to a method and to a system for planning routes that each involve stopping at numerous locations and for which a sequence of the locations is determined on the basis of the distances between the locations.

It is the objective of the present innovation to reduce the work involved in the route planning, especially the work for determining the distances between the locations that have to be taken into account.

According to a first aspect, the subject innovation proposes a method for planning routes that each involve stopping at numerous locations and for which a sequence of the locations is determined on the basis of distances between the locations. The distances between the first locations of a first route are stored in a memory in conjunction with the determination of the first route. A subsequent second route is determined on the basis of distances between locations of the second route stored in the memory and on the basis of additional distances between locations of the second route, whereby the additional distances are updated in the memory.

According to another aspect, a device is put forward for planning routes that each involve stopping at numerous locations. The device comprises a route planning unit that is configured to determine a sequence of the locations for the routes on the basis of the distances between the locations and that is connected to a memory unit. The route planning unit is configured so that distances between first locations of a first route are stored in the memory unit in conjunction with the determination of the first route, and a subsequent second route is determined on the basis of distances between locations of the second route stored in the memory unit and on the basis of distances between additional locations. The route planning unit is also configured to update the distances to the additional locations in the memory unit.

The distances between locations of the second route that have been stored in the memory or in the memory unit were advantageously already determined in conjunction with the planning of the first route, i.e. these are locations of the second route, which are also constituents of the first route.

The approach of utilizing distances that, after they have been determined in conjunction with one route, remain stored in the memory or in the memory unit for the planning of additional routes reduces the work involved in planning routes, especially the work involved in determining distances between the locations contained in the routes. In order to plan a new route, all that is necessary is to determine the distances pertaining to the locations that are not contained in the memory since they were not constituents of previous routes. In this manner, the memory is continuously filled with addresses, so that fewer and fewer distances have to be determined anew for the route planning

Moreover, the locations contained in the memory are relevant for the planning of routes since they have already been included in a route at least once before. In contrast, distances for irrelevant locations that are not going to be serviced on the routes that are to be planned do not have to be determined. This is another advantage of the as-needed determination of distances that is being put forward by the method and the device.

So that the work required for determining the distances can be reduced to the greatest extent possible, stored distances between the locations of the second route are utilized for determining the second route, if they are available in the memory. In this embodiment, in order to carry out the planning of the second route, only distances that have not already been stored in the memory are determined anew.

In order to achieve this, one embodiment of the method and of the device provides that, in conjunction with the determination of the second route, the additional locations of the second route are determined for which no associated distances are contained in the memory, and distances pertaining to these additional locations are determined and updated in the memory. The additional locations of the second route for which no associated distances are contained in the memory can be determined by comparing the locations of the second route to the locations for which distances are already stored in the memory. This checking procedure can be carried out, for example, when the locations of the second route are reported to the route planning unit.

In another embodiment of the method and of the device, the distances that are determined and updated in the memory are distances between the additional locations and/or distances between the additional locations and the locations already contained in the memory. These can be locations that are likewise constituents of the second route. By the same token, the distances to other locations that are contained in the memory can be additionally determined As a result, distances can be determined and updated that are related to locations that are not serviced on the second route. However, the updating is carried out with an eye toward possible future route planning procedures in which these distances can be used.

The distances stored in the memory can represent several variables. The routes are planned in such a way that a predetermined variable such as, for example, the distance to be traveled and/or the time for completing one or more (simultaneously planned) routes, is minimized to the extent possible. The distances stored in the memory can be adapted to the variable that is to be optimized. In one embodiment of the method and of the device, the distances are time-related distances between the locations. This means that the distance between a first and a second location indicates how much time is needed to travel from the first location to the second location. The time-related distances can be used especially to plan routes for which the required time has been minimized

In order to determine time-related distances between the locations, one embodiment of the method and of the device provides that the distances between the locations are determined as a function of determined routes between the locations. The routes can be determined in such a way that they fulfill an optimization criterion, at least to the extent possible. In particular, these can be the shortest or fastest routes.

The traffic situation has an effect on the actually traveled distances since distances can increase due to traffic hindrances such as, for example, traffic jams or road blockings. In order to take the traffic situation into account, a refinement of the method and of the device provides that the distances stored in the memory are determined and/or updated as a function of traffic information. By updating distances that have already been stored in the memory, changes in the traffic situation and resultant changes in the distances can be taken into account.

In addition or as an alternative, in one embodiment of the method and of the device, it is provided that the distances are determined on the basis of measured values acquired while the route is being traveled, and then updated in the memory. As a result, the actually traveled distances can be stored in the memory. This is done by updating distances that were computed, for example, before the route was traveled. These measured values can be, for example, detected positions and acquired times on the basis of which time-related distances between locations of the route can be determined.

Moreover, one embodiment of the method and of the device is characterized in that, for at least two locations, several distances between the locations are stored in the memory, and these distances are valid for different periods of time. In particular, these periods of time can be intervals of times of the day and/or weekdays. By storing several distances for different times, it is possible to take into consideration different traffic situations of the kind that, as a rule, occur during different periods of time during a day or week.

Another embodiment of the method and of the device comprises that, for at least two locations, several distances between the locations are stored in the memory, and these distances apply to different transportation vehicles. In this manner, it can be taken into account that not all routes are traveled with the same transportation vehicle and that the distances between the locations differ for different transportation vehicles, for example, due to the speed that can be reached and/or due to the roads that can be used.

One embodiment associated with the two above-mentioned variants provides that the first and/or the second route is determined on the basis of the distance that applies to the period of time in which one of the locations is reached and/or that applies to the transportation vehicle that is to be used.

In one embodiment of the method and of the device, the planned routes are routes for delivering and/or picking up mailpieces, and the addresses are locations where mailpieces are to be delivered and/or picked up. The route planning comprises the determination of the sequence in which the addresses are serviced by the deliverers, and it can also include the fact that the mailpieces to be delivered and/or pick-up orders are assigned to the available deliverers.

According to another aspect, the subject innovation proposes a computer program that comprises a software code containing commands for carrying out the method and its variants on a data processing system.

The above-mentioned and other advantages, special features and practical refinements of the subject innovation are explained on the basis of the embodiments, which are described below with reference to the figures.

### BRIEF DESCRIPTION OF THE DRAWINGS

FIG. 1a is a schematic depiction of a delivery depot with an associated planning unit and a delivery vehicle associated with the delivery depot,

FIG. 2a is a schematic illustration of a distance matrix in a first version, and

FIG. 2b is a schematic illustration of a distance matrix in another version.

### DETAILED DESCRIPTION OF SPECIFIC EMBODIMENT

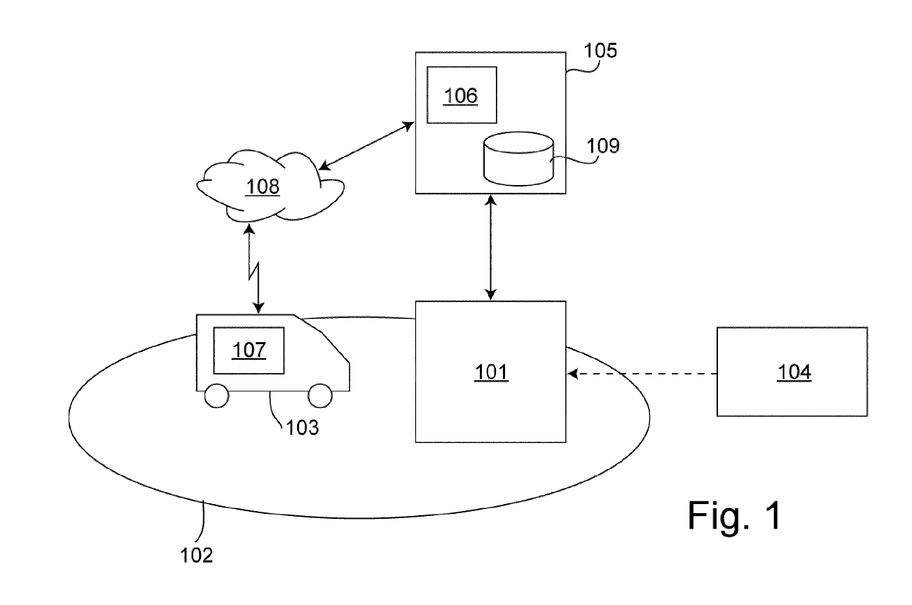

Starting from the delivery depot 101 of a postal service provider schematically shown in FIG. 1, mailpieces are delivered within a geographical area 102 associated with the delivery depot 101. Moreover, it can be provided that the deliverers associated with the delivery depot 101 pick up mailpieces from senders within the geographical area 102 if the senders have sent appertaining pick-up orders to the delivery depot 101 or to another entity of the postal service provider. The mailpieces can be packages and parcels or other mailpieces such as, for example, letters.

The delivery depot 101 has a fixed or variable number of deliverers to whom delivery vehicles 103 can be assigned that are then used by the deliverers for the delivery and/or pick-up of mailpieces. Several deliverers with an assigned delivery vehicle 103 are employed (in FIG. 1, however, only one delivery vehicle 103 is shown by way of an example). The delivery vehicles 103 can be configured as four-wheel or multi-wheel passenger cars or trucks. Fundamentally, all deliverers associated with the delivery depot 101 can use such a delivery vehicle 103. However, it can also be provided that at least some of the deliverers use other transportation vehicles for the delivery and/or pick-up of mailpieces such as, for example, two-wheeled vehicles, bicycles or mail carts for delivery on foot.

The deliverers or delivery vehicles 103 used in the delivery depot 101 travel at least one route every day in order to deliver and pick up mailpieces. By the same token, at least some of the deliverers can also travel several routes on one day. The routes start and end at the delivery depot 101 and include stops at the addresses assigned to the deliverer, where mailpieces are to be delivered and/or picked up. These addresses are referred to below as stops on the runs or routes of the deliverers.

In order to plan the routes, a planning unit 105 is provided that can be situated in the delivery depot 101 or else separately as shown in FIG. 1 by way of an example. As a data processing system, the planning unit 105 is equipped with a computer program for carrying out the route planning. The route planning carried out in the planning unit 105 comprises that the mailpieces to be delivered are distributed among the deliverers or delivery vehicles 103 available in the delivery depot 101. By the same token, the pick-up orders received are distributed among the deliverers. Moreover, the planning unit 105 likewise determines the sequence in which the individual deliverers are to service the addresses where mailpieces are to be delivered and/or picked up.

In one embodiment, the deliverers are able to communicate wirelessly with the planning unit 105 that is associated with the delivery depot 101. This is done, for instance, via a mobile telecommunications network 108 as shown in FIG. 1. For communication purposes, the delivery vehicles 103 can have a communication device (not shown in the figure). By the same token, however, the deliverers can also carry portable communication devices such as, for example, smart phones or notebook computers in order to establish data connections to the planning unit 105. Via the communication connection, especially route data such as information about the mailpieces to be delivered, pick-up orders and the sequence of the stops determined in the planning unit 105 can be transmitted to the deliverers or delivery vehicles 103. This can especially be done when a route is newly planned, and it can be carried out in order to integrate pick-ups into the route that were ordered after the deliverer had started on his/her route.

Moreover, the deliverers have a positioning device 107 for determining their position, said device being permanently installed in the delivery vehicle or being carried by the deliverer as a mobile device. The positioning device 107 can be configured as a satellite-assisted positioning device 107 that determines the position of the delivery vehicle 103 in a manner generally known to the person skilled in the art on the basis of signals of a satellite positioning system, for example, the Global Positioning System (GPS). The determined positions of the delivery vehicle 103 can be transmitted to the planning unit 105 so that, also during a route, the planning unit 105 has access to the current position of the delivery vehicle 103. In an embodiment that is explained below, this position data can also be used to track the route of the deliverer. The positioning device 107 can also be a component of a portable or permanently installed navigation system that is capable of determining a route from a position of the delivery vehicle 103 to a destination in a road network of the area 102, and it can generate acoustic and/or optical navigation instructions to guide the driver of the delivery vehicle 103 along the route to the destination, which especially can be a stop address.

Mailpieces to be delivered in the geographical area 102 are conveyed to the delivery depot 101 via a logistic system 104 of the postal service provider. This can be done, for example, once or several times per day. In one embodiment, the logistic system 104 comprises several sorting centers for mailpieces (not shown in the figure) where mailpieces are sorted and forwarded on the way from the sender to the recipient (the delivery depot 101 can likewise be a sorting center or one of several separate delivery depots that are jointly associated with one sorting center of the logistic system 104). The addresses of the mailpieces to be delivered can already be detected in the logistic system 104 and transmitted to the planning unit 105, or else the addresses are detected in the delivery depot 101 when they are received there and are transmitted to the planning unit 105. In one embodiment, the delivery addresses of the mailpieces that reach the delivery depot 101 before the beginning of the routes are included in the planning of the routes.

Pick-up orders are transmitted by the senders to the postal service provider and detected, for example, by a central installation. The transmission can be made by phone, online, for instance, via a website, or on the basis of an electronically transmitted message such as, for instance, an e-mail. From the central installation, the pick-up orders for addresses in the geographical area 102 that is associated with the delivery depot 101 can be transmitted to the planning unit 105. In one embodiment, when the planning unit 105 plans routes, it includes the pick-up orders that have been received by a certain point in time before the start of the route. Likewise, pick-up orders received later in the planning unit 105 can also be included and integrated into already planned routes. This can also be done after the deliverer has started on his/her route. In this case, the order as well as route data that might have changed due to this order, for instance, due to the sequence of the stops that might have changed due to the order, are transmitted to the deliverer via the mobile telecommunications network 108.

The route planning is carried out in the planning unit 105 on the basis of the addresses to be serviced by the deliverers and on the basis of the distances between the addresses. In this process, the association of the stops with the deliverers is made on the basis of one or more optimization criteria, for instance, in such a way that an equally distributed workload for the deliverers is achieved, and so that the total duration or length of the routes is minimized The route planning also includes the determination of the stop sequence for the routes of the individual deliverers. For purposes of the route planning, a heuristic algorithm is used in the planning unit 105 and this can be performed in a generally known manner by a person skilled in the art.

The distances used for the route planning are determined in the planning unit 105 before the routes are computed and these distances are stored in a non-volatile memory unit 109 of the planning unit 105. In order to carry out the route computation, the planning unit 105 reads the distances between the addresses to be serviced out of the memory unit 109 and uses these distances as the input variables for the route planning algorithm. In this process, for each of the addresses to be serviced and to be included in the route planning, distances are provided to all of the other addresses that are to be serviced. Subsequently, for each address, especially the distances from the other addresses to this address can be taken into account.

These distances are time-related distances that indicate how much time is needed to travel from one address to another address. As an alternative, however, the distances between the addresses or other variables can also be indicated. The variable to which the distances refer is adapted to the optimization criterion upon which the route planning is based. Thus, the distances can especially be values of a variable that is to be optimized.

The distances are stored in the memory unit 109 in a prescribed data structure, such as in a distance matrix. This matrix contains entries dᵢⱼ that each indicate the distance from an address i to an address j. The entries on the main diagonal of the distance matrix, that is to say, the entries dᵢᵢ, have a value of zero. The distance matrix is generally not symmetrical, since in any case, the distance from an address i to an address j does not necessarily correspond to the distance from the address j to the address i. A reason for differences in these distances can be, for instance, that a route from address i to address j cannot be driven in the reverse direction due to one-way streets or the like.

It is provided that the distance matrix does not have to be determined anew before every route planning procedure in the planning calculator 105. Instead, distances that have been computed one time fundamentally remain stored in the memory unit 109 and can be used for multiple route planning procedures (however, in one embodiment, the distances can be updated, which will still be described below). The determination of the distances is carried out when the associated addresses have to be serviced for the first time. When new addresses that are not included in the distance matrix have to be serviced, it is provided that the distances between the new addresses as well as the distances between the new addresses and the other addresses of the distance matrix are determined and subsequently added to the distance matrix.

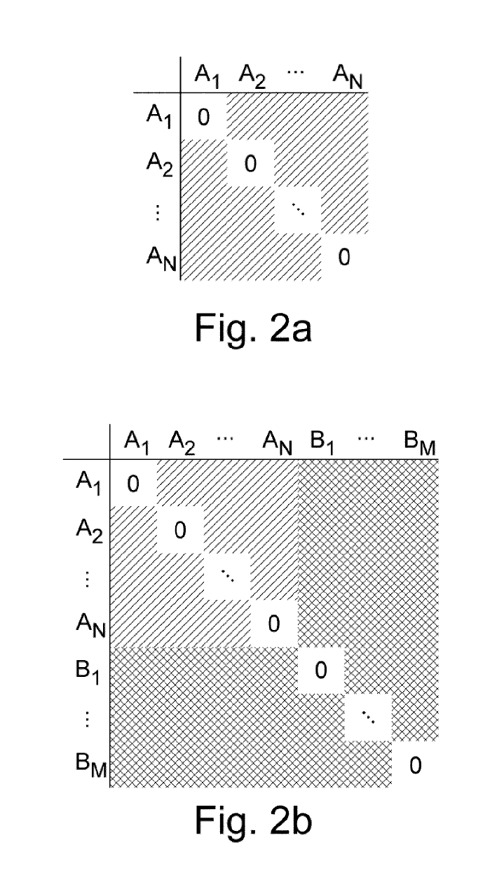

The first time, the distance matrix can be determined in order to prepare a certain route computation process on the basis of the addresses that are to be taken into consideration, and this can then be stored in the memory unit 109. FIG. 2a shows a schematic illustration of a distance matrix that can be obtained on the basis of the first-time determination. In the distance matrix shown, N addresses A₁ to A_{N} are taken into account on the basis of which the route planning process for the first-time computation of the distance matrix is carried out. Entries of the distance matrix containing the distance values are shown in FIG. 2a in a cross-hatched illustration.

When one or more addresses that have to be included in the subsequent route planning processes are transmitted to the planning unit 105, the planning unit 105 checks to see whether these addresses are already included in the version of the distance matrix that is stored in the memory unit 109. If this is the case for one or more of the received addresses, the distances used are those that are stored in the memory unit 109 referring to this address. If the planning unit 105 ascertains that one or more of the received addresses are not included in the stored version of the distance matrix, then the distances between the addresses in question as well as between the new addresses and the addresses already included in the distance matrix are determined and stored in the distance matrix. This yields a new version of the distance matrix that is stored in the memory unit 109.

FIG. 2b shows a schematic illustration of a version of the distance matrix that has been determined on the basis of the version shown in FIG. 2a after additional addresses have been reported to the planning unit 105. In the situation shown by way of an example, the additional addresses M include addresses B₁ to B_{M} that do not correspond to any of the addresses A₁ to A_{N} and that consequently were not included in the preceding version of the distance matrix. As shown in FIG. 2b, the distances between the addresses B₁ to B_{M} as well as between the addresses B₁ to B_{M} and the addresses Aₗ to A_{N} are updated in the distance matrix. The updated entries are indicated in FIG. 2b by cross-hatching that has been changed in comparison to the cross-hatching of the original entries.

In the same manner as with the first addition of distances, the distance matrix is always updated when addresses that have to be serviced by the deliverers of the delivery depot 101 and that have to be included in the route planning in the planning unit 105 are reported to the planning unit. In this manner, distances relating to addresses where mailpieces are to be delivered and/or picked up are continuously updated in the distance matrix. The addition of distances becomes less and less, since over time, fewer and fewer addresses of the geographical area 102 remain that are associated with the delivery depot 101 but that have not yet been included in the distance matrix.

In this manner, after a certain period of time, the distance matrix will have grown to a scope in which essentially all or numerous addresses that have to be taken into account for the delivery and/or pick-up of mailpieces will have been entered into the distance matrix. In contrast, addresses where mailpieces are never delivered and/or picked up, for example, because the associated sites are not in use, are not included in the distance matrix. This is an advantage of the as-needed updating of the distance matrix that leads to the fact that there is only a need to determine distances between addresses that are relevant for the delivery and/or pick-up of mailpieces.

An alternative embodiment differs from the embodiment explained above in that, for new addresses that are transmitted for a route planning process, it is not the distances to all of the addresses already included in the distance matrix that are computed, but rather, the only distances that have to be included in the route planning are those already included in the distance matrix. The planning unit determines the distances between a new address and another address that is already included in the distance matrix if both of these addresses are to be included in the route planning

In the alternative embodiment, before the planning unit 105 carries out a route planning process, it checks whether the distances between the addresses to be included are stored in the distance matrix. The distances that are not included there are updated by the planning unit 105 and, even after the route planning process, they remain stored in the memory unit 109 for purposes of carrying out further route planning processes. The checking procedure can especially be carried out when an address that has to be included in the route planning is transmitted. Here, a determination is made as to whether distances between the reported addresses and the already included addresses that are to be included in the route planning are stored in the memory unit 109. If this is not the case for one or more already contained addresses, then the distances are updated. With this embodiment as well, distances that are not present are continuously added to the distance matrix, whereby fewer and fewer addresses are added over the course of time.

In the previously described alternative embodiments, the computing power needed for planning an individual route is less since fewer distances have to be determined. However, if distances to addresses are also determined that do not have to be included in the current route planning, especially distances to all of the other addresses included in the distance matrix, then the distance matrix fills more quickly with distances that can be used later on without the need for any further computations.

In one embodiment, in order to determine the distance between a first address and a second address that are included in the distance matrix, the planning unit 105 computes a route from the first address to the second address within the road network of the geographical area 102. A route computation module 106 is provided for this purpose. In the route computation module 106, the route is computed in such a way that it meets one or more prescribed optimization criteria. In particular, the fastest or shortest route can be computed. The optimization criterion that is used for the route computation is harmonized with the optimization criterion that forms the basis on which the route planning is carried out in the planning unit 105. In particular, the same optimization criterion can be used. The planning unit 105 enters the distance resulting from the optimal route into the distance matrix.

In one embodiment, the computed optimal routes on which the distance determination is based are transmitted to the delivery vehicles 103 that are then guided along the route on this basis. For this purpose, the routes can be entered, for instance, into the navigation systems of the delivery vehicles 103 in order to guide the delivery vehicles along the routes on the basis of navigation instructions. By the same token, however, it can also be provided that routes between the individual stops are determined in the delivery vehicles 103 independently of the route determination for determining the distances. Thus, the navigation systems of the deliverers can determine the routes independently of specifications provided by the planning unit 105 and/or the deliverers determine the routes between the stops on the basis of their local knowledge of the area.

The optimal route is determined in the planning unit 105 by consulting stored map data of the road network of the geographical area 102. The map data can contain, for example, road sections of the road network with which individual distances are associated or for which the distances can be computed on the basis of data associated with the road sections. For example, a length and an average speed can be indicated for each of the road sections, on the basis of which the planning unit 105 can compute an average time-related distance needed to travel that road section. When a route from a first address to a second address is determined, individual road segments of the road network are linked to each other in such a way as to yield an optimal route from the first address to the second address. Algorithms generally known to the person skilled in the art can be used for this purpose.

Moreover, in one embodiment, the routes are computed using traffic information, on the basis of which the distances entered in the distance matrix are determined Here, long-term traffic hindrances can be taken into account such as, for example, roadblocks and/or detours as well as relatively short-term hindrances such as, for example, traffic jams. Due to the longer-term traffic hindrances, for example, certain road portions can be excluded during the route planning. The above-mentioned short-term traffic hindrances result in a greater distance for traveling on the road segments and consequently, this is taken into account in the determination of the distance. For example, during the route computation on which the distance determination is based, greater distances can be taken for individual road portions if a traffic jam has been reported for these road portions.

Since the traffic situation changes over time throughout the road network of the geographical area 102, it is provided that the distances computed on the basis of the traffic information are updated in the distance matrix. It can be updated, for instance, when there is a change in the traffic situation that can be transmitted to the planning unit 105 within the scope of the traffic information. In one embodiment, it is provided that the distances are updated as soon as the planning unit 105 has ascertained a change in the traffic situation on the basis of the traffic information it has received. In order to update a distance between a first address and a second address, a new computation of the route between the addresses is carried out on the basis of the changed traffic information or traffic situation.

As an alternative or in addition to the inclusion of traffic information and the resultant updating of the distances in the distance matrix, it can be provided that the distances are determined by acquiring and evaluating the progress of the deliverer on the completed routes. On the basis of the acquired position information and acquired times at which the positions have been reached, it is possible to determine when the deliverer reaches the stops on his/her route and which time-related distances have been traveled between the addresses of the stops. If the distance values represent other variables, additional or different measured values can also be taken into consideration which are acquired while the routes are being traveled such as, for example, the distances traveled between the stops.

The position information and, if applicable, additional data from the deliverers or the delivery vehicles 103 can be transmitted to the planning unit 105 so that it can track the deliverer and can evaluate the route traveled. By the same token, it can be provided that the positions of the delivery vehicle 103 as well as the associated timeframe and, if applicable, additional information can be logged in the positioning device and transmitted to the planning unit 105, for instance, each time a route has been completed.

By including the data acquired by the deliverers or in the delivery vehicles 103, the distances between a first address and a second address that were actually traveled by deliverers on a traveled route from the first address to the second address can be entered. In this manner, very realistic values can be provided in the matrix. If the same route is traveled several times, it can also be provided that average values of the actually traveled distances are computed and incorporated as distance values in the distance matrix in order to reduce the influence of special circumstances on individual delivery routes.

The distance values that have been determined on the basis of actually traveled distances are entered by updating the computed distances contained in the distance matrix. In other words, before a deliverer has traveled a route between two addresses and before the associated position data is available, a computed distance is entered in the distance matrix. This is then replaced by the distance that has been determined on the basis of the acquired data after a deliverer has traveled a route between the addresses.

Moreover, the distances between the addresses included in the distance matrix generally change, depending on the time of day and/or on the day of the week, when traffic information is taken into account in the distance matrix. The reason for this is the normal fluctuation in traffic density that is greater, for example, during rush hour than at the other times. In order to take into account the fluctuations in the distances, it can be provided that several distance matrixes are stored in the memory unit 109 that are each valid for (only) a specific period of time, especially for a specific time of day and/or for a specific day of the week. As an alternative, it can also be provided that the individual entries of the distance matrix each comprise several components that are each valid for different periods of time. In this embodiment, the distance matrix can be configured to have more than two dimensions. The distances associated with the various periods of time are average distances that are typically needed to travel the routes between the addresses in question during the validity periods. They can be determined as a function of traffic information and/or of acquired measured values.

In another embodiment in which the deliverers use different transportation vehicles for the delivery and/or pick-up of mailpieces, it can be provided that several distance matrixes are stored in the memory unit 109 and associated with a given transportation vehicle, or as an alternative, the entries of the distance matrix contain several components that are each associated with a given transportation vehicle. These embodiments can also be combined with the embodiments described above in which different distances are indicated for different periods of time.

If, as described above, several values are provided for one or more distances, all of the distance values are added when the associated location is reported to the planning unit 105. Likewise, however, it can also be provided that the determination is made on an as-needed basis, i.e. when the distance values are needed for the route planning

In the distance matrix that was computed in the manner described above, realistic distances between numerous addresses of the geographical area 102 associated with the delivery depot 101 are always available in the planning unit 105 for the route planning The distances do not have to be computed anew for each route planning process, as a result of which the route planning can be carried out more quickly.

Moreover, the required distances are also available when new planning has to be carried out on short notice for one or more routes.

Such new planning can be provided, for example, so that pick-up orders that are received in the planning unit 105 after the start of a delivery route can be integrated into the delivery route. If the address of the pick-up order was not previously included in the distance matrix, then the new planning of the route merely requires a determination of the distances between this address and the other addresses that have been included in the distance matrix. If the address was already included in the distance matrix, then there is no need at all for a distance computation in order to carry out the new planning of the delivery route.

Although the subject innovation was described in detail in the drawings and in the presentation above, the presentations are to be considered as being illustrative and provided by way of an example, but are not to be construed as being of a limiting nature; in particular, the subject innovation is not restricted to the elucidated embodiments. The person skilled in the art can glean additional variants of the subject innovation and its execution from the preceding disclosure, from the figures and from the patent claims.

In the patent claims, terms such as “encompass”, “comprise”, “contain”, “have” and the like do not exclude additional elements or steps. The use of the indefinite article does not preclude the plural. Each individual device can execute the functions of several of the units or devices cited in the patent claims. The reference numerals indicated in the patent claims are not to be construed as a limitation of the articles and steps employed.

1-14. (canceled)

15. A method for planning routes, wherein each route involves stopping at numerous locations, comprising:
determining a sequence of the locations on the basis of the distances between the locations, wherein the distances between first locations of a first route are stored in the memory unit in conjunction with the determination of the first route; and
determining a subsequent second route on the basis of distances between locations of the second route stored in the memory unit and on the basis of distances between additional locations of the second route, wherein the additional distances are updated in the memory.

16. The method according to claim 15, wherein stored distances between the locations of the second route are utilized for determining the second route, if they are available in the memory.

17. The method according to claim 16, comprising:
determining, in conjunction with the determination of the second route, the additional locations of the second route for which no associated distances are contained in the memory, and
determining the distances pertaining to these additional locations; and
storing the distances pertaining to the additional locations in the memory unit.

18. The method according to claim 17, wherein distances between the additional locations and/or distances between the additional locations and the locations already contained in the memory are determined and updated in the memory.

19. The method according to claim 15, wherein the distances are time-related distances.

20. The method according to claim 15, wherein the distances between the locations are determined as a function of determined routes between the locations.

21. The method according to claim 15, wherein the distances stored in the memory are determined and/or updated as a function of traffic information.

22. The method according to claim 15, wherein the distances are determined on the basis of measured values acquired while the route is being traveled, and then updated in the memory.

23. The method according to claim 15, wherein, for at least two locations, a plurality of distances between the locations are stored in the memory, and wherein these distances are valid for different periods of time.

24. The method according to claim 23, wherein one of the routes is determined on the basis of the distance that applies to the period of time in which one of the locations is reached.

25. The method according to claim 15, wherein, for at least two locations, a plurality of distances between the locations are stored in the memory, and wherein these distances apply to different transportation vehicles.

26. The method according to claim 25, wherein one of the routes is determined on the basis of the distance that applies to a transportation vehicle that is to be used.

27. The method according to claim 15, wherein the routes for delivering and/or picking up mailpieces are planned, and wherein the locations are physical addresses where mailpieces are to be delivered and/or picked up.

28. A non-transitory, tangible, computer readable storage devices, comprising code configured to direct a processor to:
determine a sequence of the locations on the basis of the distances between the locations, wherein the distances between first locations of a first route are stored in the memory unit in conjunction with the determination of the first route; and
determine a subsequent second route on the basis of distances between locations of the second route stored in the memory unit and on the basis of distances between additional locations of the second route, wherein the additional distances are updated in the memory.

29. A device for planning routes that each involve stopping at numerous locations, comprising a route planning unit that is configured to:
determine a sequence of the locations for the routes on the basis of the distances between the locations and that is connected to a memory unit, wherein the route planning unit is configured so that distances between first locations of a first route are stored in the memory unit in conjunction with the determination of the first route, and
determined a subsequent second route on the basis of distances between locations of the second route stored in the memory unit and on the basis of distances between additional locations, wherein the route planning unit is configured to update the distances to the additional locations in the memory unit.

30. The device according to claim 28, wherein stored distances between the locations of the second route are utilized for determining the second route, if they are available in the memory unit.

31. The device according to claim 29, wherein the route planning unit is configured to:
determine, in conjunction with the determination of the second route, the additional locations of the second route for which no associated distances are contained in the memory unit, and
determine the distances pertaining to these additional locations; and
store the distances pertaining to the additional locations in the memory unit.

32. The method according to claim 28, wherein the distances are time-related distances.

33. The method according to claim 28, wherein the distances between the locations are determined as a function of determined routes between the locations.

34. The method according to claim 28, wherein the distances stored in the memory are determined and/or updated as a function of traffic information.

35. The method according to claim 28, wherein the distances are determined on the basis of measured values acquired while the route is being traveled, and then updated in the memory.

36. The method according to claim 15, wherein, for at least two locations, a plurality of distances between the locations are stored in the memory, and wherein:
the plurality of distances are valid for different periods of time;
the plurality of distances apply to different means of transportation; or
the plurality of distances are valid for different period and apply to different transportation vehicles.
